(19) United States
(12) Patent Application Publication
(10) Pub. No.: US 2009/0005988 A1
(43) Pub. Date: Jan. 1, 2009

(54) Vehicle pursuit caution light

(76) Inventor: Jerome J. Sterling, Los Angeles, CA (US)

Correspondence Address: Richard C. Litman;LITMAN LAW OFFICES, LTD., P.O. BOX 15035, Arlington, VA, 22215, US

(21) Appl. No.: 12/219,582

(22) Filed: Jul. 24, 2008

Related U.S. Application Data
(63) Continuation of application No. 10/864,521, filed on Jun. 10, 2004.

(51) Int. Cl. G08G 1/16

(52) U.S. Cl. 701/301

(57) ABSTRACT

A vehicle pursuit caution light system includes at least one transmitting device and at least one receiving device. The transmitting device includes a power source, control logic, a transmitter, and an antenna. The transmitting device may also include a GPS receiver to determine the transmitting device's location or coordinate values relative to a predetermined reference point. The receiving device is configured for receiving a signal having a predetermined minimum signal strength and a predetermined frequency. The receiving device includes a power source, control logic, a receiver, a visual/audible indicator, and an antenna. The receiving device may also include a GPS receiver and a mapping display.

### BACKGROUND OF THE INVENTION

1. Field of the Invention

The present invention relates generally to safety systems and, more particularly, to a vehicle pursuit caution light.

2. Description of the Related Art

Police vehicles or helicopters during vehicle pursuits are inherently dangerous to other vehicles and/or pedestrians positioned on and/or near the route on which the vehicle pursuit occurs. Law enforcement vehicles are commonly equipped with emergency sirens and lights that are activated to alert motorists ii to pull to the side of the road during vehicle pursuits. However, many typical vehicles are equipped with sound equipment and doors that inhibit the ability of active emergency sirens and lights to alert the vehicle drivers of vehicle pursuits. There is a need for a vehicle pursuit caution light that would give drivers a chance to recognize a vehicle pursuit even when a vehicle pursuit is not heard and/or seen.

The related art is represented by the following references of interest.

U.S. Patent Application Publication No. 2002/0008635 A1, published on Jan. 24, 2002 for Jimmie L. Ewing et al., describes a warning system for alerting the driver of a private vehicle that an emergency vehicle is approaching. U.S. Patent Application. Publication No. 2002/0161524 A1, published on Oct. 31, 2002 for Dale F. Oexmann et al., describes a vehicle collision warning system. U.S. Design Pat. No. 344,243, issued on Feb. 15, 1994 to Frank Peraino et al., shows an ornamental design for an emergency vehicle warning signal for automobiles. U.S. Pat. No. 3,233,217, issued on Feb. 1, 1966 to George F. Bost, Jr., describes a vehicle signal device. U.S. Pat. No. 3,710,313, issued on Jan. 9, 1973 to Pleasant P. Kimball et al., describes an emergency warning transmission system wherein the emergency vehicle transmitter instrument is capable of plural mode transmission operation to enable selection of one of several types of warning transmission.

U.S. Pat. No. 4,952,931, issued on Aug. 28, 1990 to Ahmedelhadi Y. Sergaldin et al., describes a signal adaptive processor for detecting and identifying specific sound signals that are emitted by relatively moving or at rest sources in noisy environments. U.S. Pat. No. 5,235,329, issued on Aug. 10, 1993 to LeGrant Jackson, describes an emergency vehicle detection device. U.S. Pat. No. 5,278,553, issued on Jan. 11, 1994 tot Robert H. Cornett et al., describes a method and apparatus for warning a motor vehicle operator of an approaching emergency motor vehicle having a sounding sound. U.S. Pat. No. 5,307,060, issued on Apr. 26, 1994 to Sy. Prevulsky et al., describes an emergency vehicle alert system.

U.S. Pat. No. 5,495,243, issued on Feb. 27, 1996 to Lou McKenna, describes a light activated alarm system for indicating to the occupants of a second vehicle the presence of a first vehicle. U.S. Pat. No. 5,572,201, issued on Nov. 5, 1996 to Paul D. Graham et al., describes a warning system for alerting a person includes a transmitter responsive to a visual or acoustic alerting system for transmitting an alarm signal on an RF carrier and a control signal on a sideband of the carrier. U.S. Pat. No. 5,739,767, issued on Apr. 14, 1998 to Asia Carr, describes a vehicle warning system device that is capable of detecting sirens of approaching vehicles.

U.S. Pat. No. 5,757,284, issued on May 26, 1998 to Christopher Trizzino et al., describes a system and method for alerting a driver of a motor vehicle of the approach of an emergency vehicle in an emergency state. U.S. Pat. No. 5,808,560, issued on Sep. 15, 1998 to Michael L. Mulanax, describes an emergency vehicle alert apparatus for identifying the presence of an emergency vehicle in the immediate vicinity of a motor vehicle. U.S. Pat. No. 5,926,112, issued on Jul. 20, 1999 to Chris Hartzell, describes an emergency vehicle warning system for warning vehicles of the approach of an emergency vehicle.

U.S. Pat. No. 5,933,093, issued on Aug. 3, 1999 to John H. Austin, II, describes an emergency vehicle alert device. U.S. Pat. No. 6,011,492, issued on Jan. 4, 2000 to Carl E.; Garasché, describes a vehicle warning system. U.S. Pat. No. 6,087,961, issued on Jul. 11, 2000 and to Paul A. Markow, describe a system for warning motorists of the presence of an emergency vehicle. U.S. Pat. No. 6,222,461 B1, issued on Apr. 24, 2001 to Gary L. Hazen, describes an emergency warning system for buses, trucks, or other vehicles. U.S. Pat. No. 6,252,521 B1, issued on Jun. 26, 2001 to Willie J. Griffin et al., describes an emergency vehicle alert system.

Japan Patent Application Publication No. 55-11903, published on Jan. 28, 1980, describes a vehicle notifying system for notifying the approach of an emergency vehicle. Japan Patent Application Publication No. 9-126619, published on Jun. 20, 1997, describes an antenna for receiving a proximity warning radio wave from an emergency vehicle. Japan Patent Application Publication No. 9-319996, published on Dec. 12, 1997, describes an emergency warning board for a toll road and warning system. Japan Patent Application Publication No. 10-40492, published on Feb. 13, 1998, describes an emergency vehicle warning system.

None of the above inventions and patents, taken either singularly or in combination, is seen to describe a vehicle pursuit caution light according to the claimed invention. Thus a; vehicle pursuit caution light solving the aforementioned problems is desired.

### SUMMARY OF THE INVENTION

The present invention is a vehicle pursuit caution light. A vehicle pursuit caution light system includes at least one transmitting device and at least one receiving device. The transmitting device includes a power source, control logic, a transmitter, and an antenna. The transmitting device may also include a global position system (GPS) receiver configured to determine the transmitting device's location or coordinate values relative to a predetermined reference point. The receiving device is configured for receiving a signal having a predetermined minimum signal strength and a predetermined frequency. The receiving device includes a power source, control logic, a receiver, a visual indicator, an audible indicator, and an antenna. The receiving device may also include a GPS receiver and a mapping display.

Accordingly, it is a principal aspect of the invention to provide a vehicle pursuit caution light system including at least one vehicle pursuit transmitting device, each transmitting device including a power source, control logic, a transmitter, and an antenna, and being configured to transmit a signal having a predetermined maximum signal strength and a predetermined frequency; and at least one vehicle pursuit receiving device, each receiving device including a power source, control logic, a receiver, an antenna, and a visual/audible indicator, and being configured to receive a signal having a predetermined minimum signal strength and a predetermined frequency, whereby the visual/audible indicator blinks/sounds at a rate dependent upon the strength of the signal received by an associated vehicle pursuit receiving device.

It is another aspect of the present invention to provide a vehicle pursuit caution light system including at least one transmitting device, each transmitting device including a power source, control logic, a transmitter, an antenna, and a GPS receiver configured to determine a location of the transmitting device or coordinate values of the transmitting device relative to a predetermined reference point, and the transmitter being configured to transmit a signal having a predetermined maximum signal strength and a predetermined frequency; and at least one receiving device, each receiving device including a power source, control logic, a receiver, an antenna, a mapping display, and an audible indicator, the receiver being configured to receive a signal having a predetermined minimum signal strength and predetermined frequency, and the mapping display being configured to cause an indication of the location of the transmitting device on the mapping display to be a predetermined color blink and to cause the audible indicator to emit a designated sound at a rate dependent upon the strength of the signal received by an associated vehicle pursuit receiving device.

It is an aspect of the invention to provide improved elements and arrangements thereof in a vehicle pursuit caution light for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental view of a family that has been alerted by a vehicle pursuit caution signal that has been transmitted by a police vehicle in pursuit of a fleeing vehicle according to the present invention.

FIG. 2 is a top view of the vehicle pursuit shown in FIG. 1.

FIG. 3A is a top view of a law enforcement vehicle and a helicopter pursuing a vehicle approaching a traffic intersection according to the present invention.

FIG. 3B is a top view of a law enforcement vehicle and a helicopter pursuing a vehicle passing through a traffic intersection according to the present invention.

FIG. 4 is block diagram of a vehicle pursuit caution light, system according to the present invention.

FIG. 5 is a front view of a dashboard of a vehicle equipped with part of a vehicle pursuit caution light system according to the present invention.

FIG. 6 is a front view of a dashboard of a vehicle equipped with part of a vehicle pursuit caution light system according to the present invention.

Similar reference characters denote corresponding features consistently throughout the attached drawings.

### DETAILED DESCRIPTION OF THE PREFERRED EMBODIMENTS

The present invention is a vehicle pursuit caution light. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

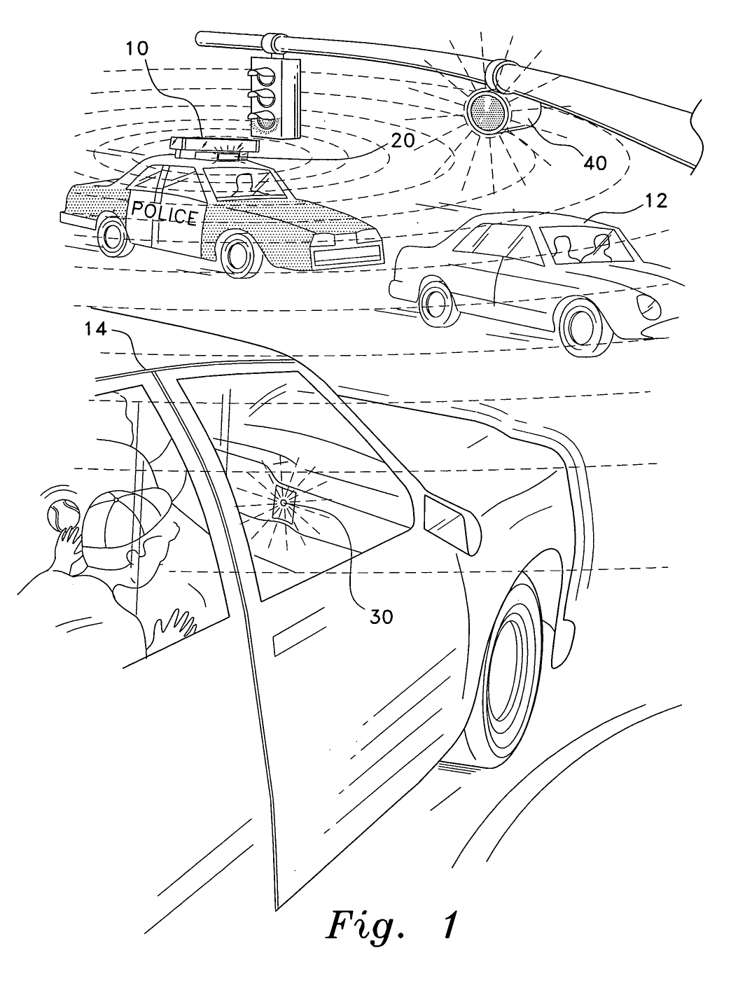

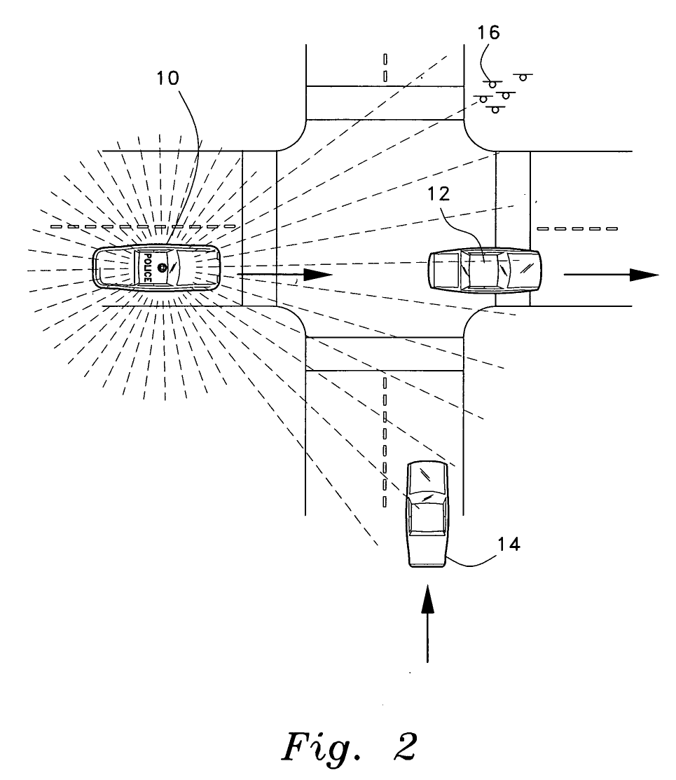

Referring to the drawings, FIGS. 1 and 2 show a police lit vehicle 10 in pursuit of a fleeing vehicle 12. A family in the vehicle 14 has been alerted due to a pursuit signal that has been, transmitted from a vehicle pursuit transmitting device 20 on the police vehicle 10. The pursuit signal causes the vehicle pursuit caution light 30 to blink and/or sound at a rate dependent upon the strength of the signal received by the caution light 30. The pursuit signal also causes a larger vehicle pursuit caution light 40 mounted or strapped on a signal light beam to blink, ii and/or sound at a rate dependent upon the strength of the signal received by the caution light 40. Any nearby pedestrian 16 may also be equipped with and/or be carrying a vehicle pursuit caution light according to the invention, and lives may be saved.

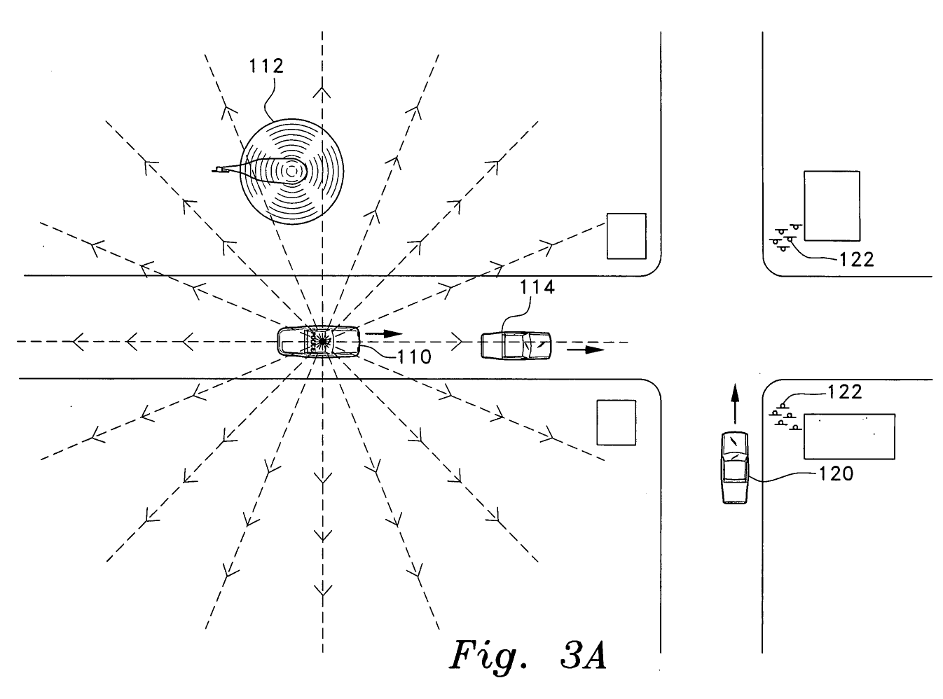

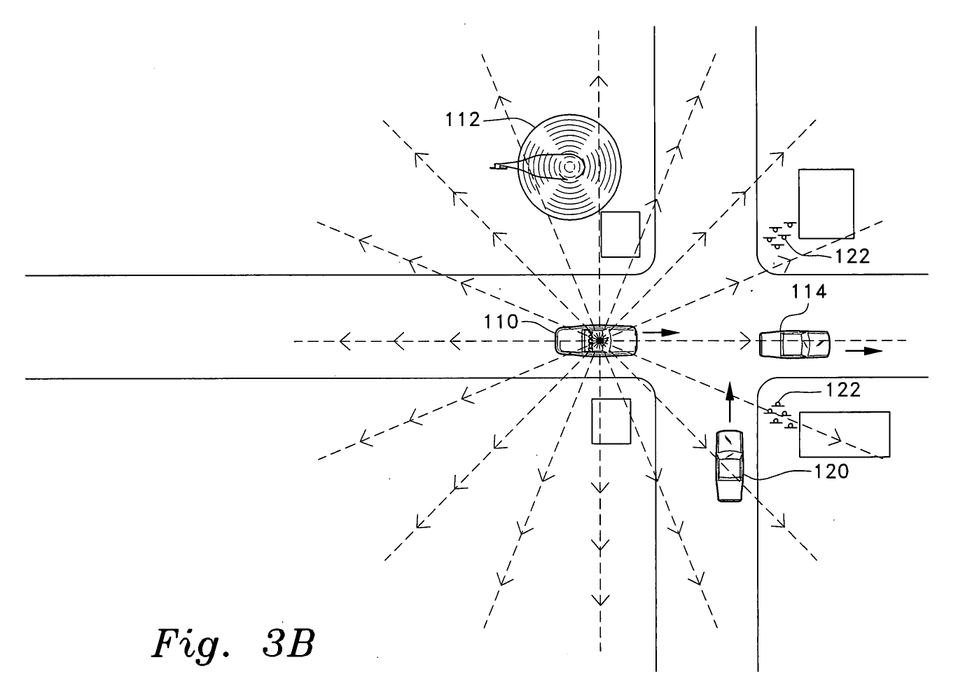

FIGS. 3A and 3B illustrate a vehicle pursuit in progress. As shown in FIG. 3A, a police vehicle 110 and a law enforcement helicopter 112 are pursuing a vehicle 114 and are approaching an intersection. The police vehicle 110 is equipped with a vehicle pursuit transmitting device and is transmitting a pursuit signal 100. The law enforcement helicopter 112 may also be equipped with a vehicle pursuit transmitting device and be transmitting a pursuit signal. The pursuit signal 100 is transmitted from the police vehicle 110 at a predetermined frequency and with a predetermined signal strength. Another vehicle 120 is approaching the intersection and pedestrians 122 are near the intersection. The motor vehicle 114 and the motor vehicle 120 may have installed and/or mounted therein, and/or the pedestrians 122 may be carrying a vehicle pursuit receiving device according to the invention.

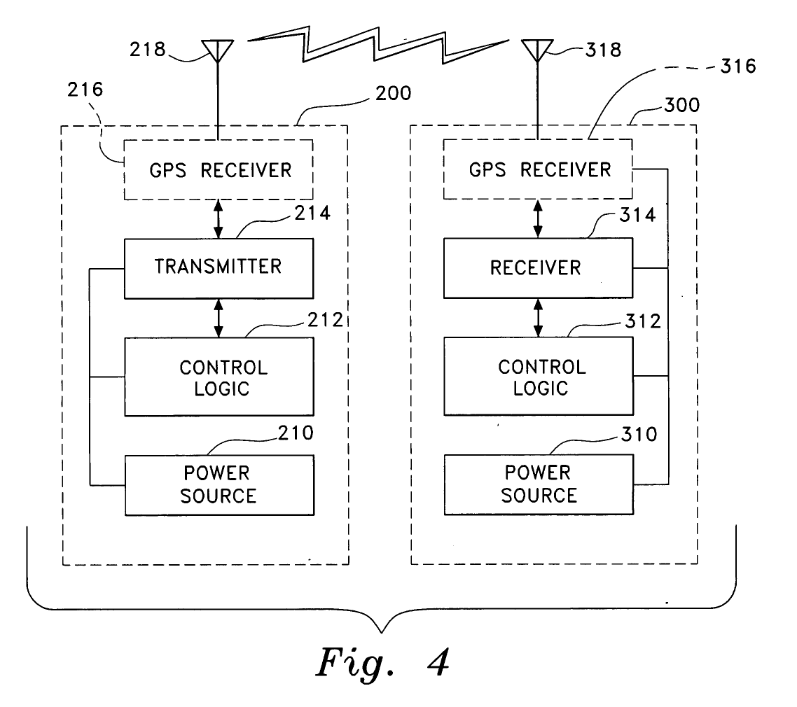

Referring to FIG. 4, a vehicle pursuit caution light system includes at least one transmitting device 200 and at least one receiving device 300. The transmitting device 200 includes a power source 210, control logic 212, a transmitter 214, and an antenna 218. The transmitting device 200 may be installed and/or mounted in any type of law enforcement vehicle, such as a police vehicle, a law enforcement helicopter, or the like. The transmitting device 200 may be also be portably configured to facilitate carriage by an individual (e.g., in the form of a pager, personal digital assistant, etc.).

The transmitting device 200 is configured for transmitting al pursuit signal, such as a high radio frequency signal or the al like, having a predetermined maximum signal strength and a predetermined frequency. The transmitting device 200 is activated to transmit a pursuit signal by manual input from a user, e.g., by a switch, button, or the like. The power source 210 may be any desired power source, such as a twelve volt battery of a motor vehicle, a portable battery power source, or the like. The control logic 212 may be configured as firmware with any number of logic gates or may be realized as a microprocessor, a micro-controller, etc. The transmitter 214 may be any type of transmitter configured for transmitting a pursuit signal having a predetermined maximum signal strength enabling signal reception by an appropriately configured vehicle pursuit receiving device 300 within a relatively small predetermined range from the transmitting device 200, preferably about one-half mile.

The transmitting device 200 may also include a GPS receiver 216 configured to determine the location of the transmitting device 200 or coordinate values of the transmitting device 200 relative to a predetermined reference point. In addition, a pursuit signal transmitted from the vehicle pursuit transmitter may include GPS coordinate information of the transmitting device 200. While such a receiver is referred to as a GPS receiver, any other positioning receiver may alternatively be utilized in the transmitting device 200, such as a Global Navigational System (GLONASS) receiver.

The vehicle pursuit receiving device 300 is configured for receiving a pursuit signal, such as a-high radio frequency signal or the like, having a predetermined minimum signal strength and a predetermined frequency. The receiving device 300 includes a power source 310, control logic 312, a receiver 314, and an antenna 318. The receiving device 300 also includes a visual indicator and/or an audible indicator. The receiving device 300 may be installed in and/or mounted in any type of motor vehicle, such as a passenger vehicle, a school bus, a commercial bus, a truck, or the like. The receiving device 300 may also be portably configured to enable carriage by an individual (e.g., in the form of a pager, a PDA, etc.).

The power source 310 of the receiving device 300 is, preferably a motor vehicle battery a motor vehicle in which the receiving device 300 is installed and/or mounted. The power source 310 of the receiving device 300 may also be configured in the form of a small battery to enable portable carriage by an individual. However, the receiving device 300 may also include a removable rechargeable battery to enable the receiving device 3001 to be active and/or powered when a pursuit signal is received from a transmitting device 200 and the receiving device 300 is mounted in a motor vehicle that is turned off or is portable and is being carried by an individual. The control logic 312 may be configured as firmware with any number of logic gates or may be realized as a microprocessor, a micro-controller, etc. The visual indicator may be any type of light, such as a light emitting diode or the like. The audible indicator may be any type of sound emitter, such as a speaker installed in a motor, vehicle, a speaker installed in a portable vehicle pursuit receiving device, or the like.

The receiving device 300 may also include a display, such as a liquid crystal display or the like. The receiving device 300 is configured for receiving the above described pursuit signal and activating the visual indicator and/or the audible indicator. The visual indicator may be configured for blinking and the audible indicator may be configured for emitting a designated sound at a rate dependent upon the strength of the pursuit signal received from a transmitting device 200. The visual indicator may also be configured for constant illumination and the audible indicator may be configured for constant sound emission when the strength of a pursuit signal received from a transmitting device 200 reaches a predetermined maximum level. When the motor vehicle is equipped with a GPS receiver 316 and a corresponding mapping display, the GPS receiver 316 may extract GPS coordinate information from a received pursuit signal regarding the location, of the corresponding transmitting device 200, and provide an indication of the relative location of the corresponding transmitting device 200 on the display of the motor vehicle.

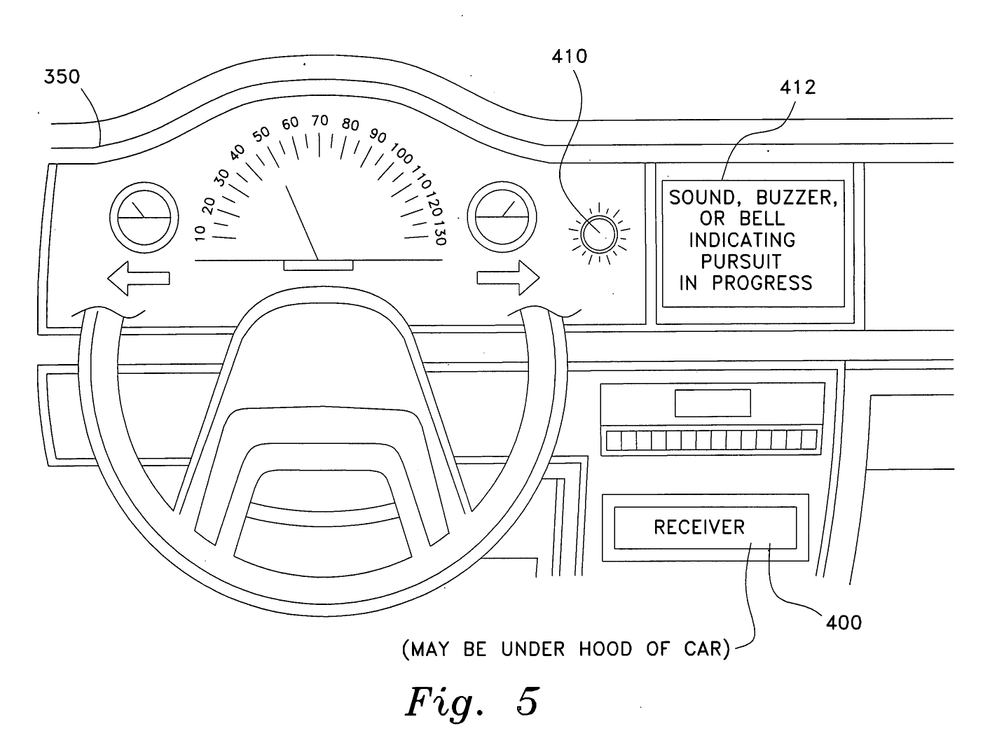

FIG. 5 illustrates a dashboard 350 of a motor vehicle equipped with a vehicle pursuit receiving device according to the invention. The vehicle pursuit receiving device includes a power source, control logic, a vehicle pursuit receiver 400, a visual indicator 410, an audible indicator 412, and an antenna. This particular receiver 400 is configured to cause the visual indicator 410 to blink and the audible indicator 412 to emit a designated sound at a rate dependent upon the strength of a pursuit signal received from a vehicle pursuit transmitting device.

The receiver 400 is configured to cause the visual indicator 410, such as a yellow light or the like, to blink at a rate and to cause the audible indicator 412, such as a motor vehicle speaker or the like, to emit an audible sound that both increase as the strength of the received signal increases and decrease as the strength of the received signal decreases, indicating a corresponding reduction or increase in distance between the vehicle pursuit transmitting device and the receiver 400 over a predetermined range, preferably about one-half mile. For example, the visual indicator 410 may be a yellow light and the audible indicator may be a sound, buzzer, bell, or the like.

The visual indicator 410 is also configured to provide constant illumination and the audible indicator 412 is configured to provide constant sound emission when the strength of a vehicle pursuit signal received from a vehicle pursuit transmitting device reaches a predetermined maximum level.

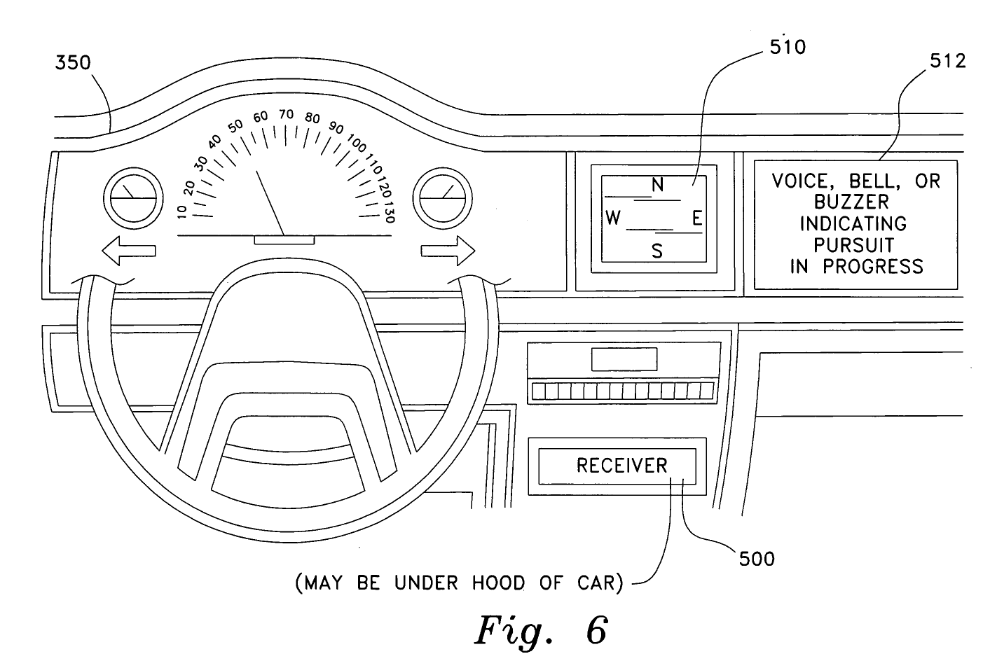

FIG. 6 illustrates a dashboard 350 of a motor vehicle equipped with another vehicle pursuit receiving device according to the invention. This receiving device includes a power source, control logic, a receiver 500, a mapping display 510, an audible indicator 512, and an antenna. The motor vehicle within which this receiving device includes a GPS receiver interconnected with the GPS mapping display. When the receiver 500 receives a pursuit signal from an associated transmitting device, the receiver 500 extracts GPS coordinate information from the pursuit signal and provides an indication of the relative location of the corresponding transmitting device on the mapping display 510 of the motor vehicle.

This particular receiver 500 may be configured to cause the mapping display 512 to blink and the audible indicator to emit a designated sound at a rate dependent upon the strength of a pursuit signal received from a transmitting device. The receiver 500 is configured to cause the indication of the transmitting device location on the mapping display 512 to be a predetermined, such as a yellow light or the like, and to blink at a rate and to cause the audible indicator, such as a motor vehicle speaker or the like, to emit an audible sound that both increase as the strength of the received signal increases and decrease as the strength of the received signal decreases, indicating a corresponding reduction or increase in distance between the transmitting device and the receiver 500 over a predetermined range, preferably about one-half mile. For example, the visual indicator 510 may be a yellow light and the audible indicator may be a voice message (e.g., ‘Pursuit in Progress’, etc.), a bell, a buzzer, or the like.

The mapping display 510 is also configured to provide constant illumination of the transmitting device location indication, and the audible indicator is configured to provide constant sound emission when the strength of the signal received, from a transmitting device reaches a predetermined maximum level.

Communities world wide may install vehicle pursuit transmitting devices in their police vehicles, and vehicle pursuit receiving devices may be installed and/or mounted in motor vehicles of other community individuals, as well as in the police vehicles. When a police office traveling in a police vehicle attempts to pull an individual over, and the individual refuses and speeds away, the police officer could activate the transmitter in his/her police vehicle. Any motorist or pedestrian with a vehicle pursuit receiving device would automatically have a yellow light on the dashboard start flashing if they were within a range of about one-half mile from the police vehicle. This would alert drivers to the potential danger so they could stay on high alert or pull to the roadside for the police vehicle and fleeing individual to pass. The closer the transmitting device of the police vehicle is to a particular motorist or pedestrian, the faster the warning light would flash, providing added information to the driver. The vehicle pursuit caution light could also be helpful and effective in preventing innocent motorists and/or pedestrians from potential danger, such as terrorist situations involving motor vehicles with bombs or the like.

While the vehicle pursuit caution light system could be used by any motorist and/or pedestrian, it may prove especially helpful to the hearing-impaired, elderly drivers with slower reflexes, and individuals who blast sound systems (and do not hear sirens). The vehicle pursuit caution light system could be installed and/or mounted in aftermarket vehicles, as well as be incorporated into new vehicle production.

The vehicle pursuit caution light provides ease of use, safety, and peace of mind for motorists and/or pedestrians. The advanced warning could provide a driver with more time to react and yield the right of way to a pursuit vehicle. This could enhance a police officer's ability to follow and arrest a fleeing criminal since streets would not be clogged with other, unsuspecting motorists. It could improve the chances of capturing a criminal when a police office is given a clear path of pursuit. The vehicle pursuit caution light could help prevent serious collisions at intersections involving emergency vehicles, or criminals plowing into traffic at high speed. This could help eliminate serious vehicular damage, higher insurance costs, injuries, and possibilities. The vehicle pursuit caution light is reliable, effective, and easily understood.

The vehicle pursuit caution light (VPCL) was formulated to alert unsuspecting motorists of impending danger when a person or persons of an unlawful flight from a law enforcement agency is in close proximity. The VPCL device could save lives and damages to property. The VPCL alert could also assist law enforcement in apprehending the driver of the fleeing vehicle quickly and safely because unsuspecting motorists with the VPCL installed would pull over to the side of the road or highway instantly upon seeing the alert.

In times past, there have been unfortunate situations that caused citizens, unsuspecting motorists, to be caught at the mercies of the fleeing vehicle driver and law enforcement that were in high pursuit and did not have an alert soon enough of the impending vehicular danger and lost their lives.

With the VPCL installed in vehicles of police, citizens, helicopters, through the technology of high frequency sound waves transmitted from police vehicles and helicopters to alert motorists with the VCPL installed, having a high frequency receiver to pick up the transmitting alert of the sound waves, within about a one-half mile radius of pursuit activity would give motorists ample time to assess their position and respond accordingly.

The VPCL could possibly be used in other ways to alert the public, such as a VPCL in a larger variation to be placed on signal lights at key intersections of the city to alert children and adults as well, that are walking, riding bikes, wheelchairs, etc. The predominate concentration of VPCL use is on the growing epidemic of police car pursuits.

The inventor respectfully submits that the VCPL is one of the best inventions to date to respond in assisting to protection of the lives of citizens against the growing numbers of police agency high speed car pursuits.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1: A vehicle pursuit caution light system comprising:
at least one vehicle pursuit transmitting device, each transmitting device including a power source, control logic, a transmitter, and an antenna, and being configured to transmit a signal having a predetermined maximum signal strength and a predetermined frequency; and
at least one mobile vehicle pursuit receiving device, each mobile receiving device including a power source, control logic, a receiver, an antenna, and a mobile visual/audible indicator, and being configured to receive a signal having a predetermined minimum signal strength and a predetermined frequency; and
at least one stationary vehicle pursuit receiving device, each stationary receiving device including a stationary power source, stationary control logic, a stationary receiver, a stationary antenna, and a stationary visual/audible indicator, and being configured to receive the signal having the predetermined minimum signal strength and the predetermined frequency, said at least one stationary vehicle pursuit receiving device being located in an external environment,
whereby the respective mobile and stationary visual/audible indicators of said at least one mobile vehicle pursuit receiving device and said at least one stationary vehicle pursuit receiving device blink/sound at a rate dependent upon the strength of the signal received by an associated vehicle pursuit receiving device.

2: The vehicle pursuit caution light system according to claim 1, wherein each of said mobile and stationary visual/audible indicators is further configured to blink in a yellow color at a rate dependent upon the strength of the signal received by the associated vehicle pursuit receiving device.

3: The vehicle pursuit caution light system according to claim 1, wherein each of said mobile and stationary visual/audible indicators is further configured to emit a designated sound.

4: The vehicle pursuit caution light system according to claim 3, wherein said designated sound is a buzzer.

5: The vehicle pursuit caution light system according to claim 3, wherein said designated sound is a bell.

6: The vehicle pursuit caution light system according to claim 1, wherein each of said mobile and stationary visual/audible indicators is further configured to provide constant illumination in a yellow color and to provide constant sound emission when the strength of a signal received by an associated receiving device reaches a predetermined maximum level.

7: The vehicle pursuit caution light system according to claim 1, wherein said predetermined maximum signal strength is effective for about one-half mile.

8: The vehicle pursuit caution light system according to claim 1, wherein each transmitting device further comprises a position system receiver configured to determine a location of the transmitting device or coordinate values of the transmitting device relative to a predetermined reference point, said transmitting device being configured to transmit a signal including data relating to a location of the transmitting device.

9: The vehicle pursuit caution light system according to claim 8, wherein each mobile receiving device further comprises a position system receiver.

10: The vehicle pursuit caution light system according to claim 9, wherein said mobile receiving device further comprises a mapping display.

11: The vehicle pursuit caution light system according to claim 10, wherein said mobile receiver is configured to extract coordinate information from a received signal regarding the location of the corresponding transmitting device, and provide an indication of the relative location of the corresponding transmitting device on the display of the motor vehicle.

12: A vehicle pursuit caution light system comprising:
at least one transmitting device, each transmitting device including a power source, control logic, a transmitter, an antenna, and a global position system receiver configured to determine a location of the transmitting device or coordinate values of the transmitting device relative to a predetermined reference point, and the transmitter being configured to transmit a signal having a predetermined maximum signal strength and a predetermined frequency coupled with data relating to a location of the transmitting device;
at least one mobile receiving device, each mobile receiving device including a power source, control logic, a receiver, an antenna, a mapping display, and a mobile audible indicator, the receiver being configured to receive a signal having a predetermined minimum signal strength and a predetermined frequency, and the mapping display being configured to cause an indication of the location of the transmitting device on the mapping display to be a predetermined color blink and to cause the mobile audible indicator to emit a designated sound at a rate dependent upon the strength of the signal received by an associated vehicle pursuit receiving device; and
at least one stationary vehicle pursuit receiving device, each stationary receiving device including a stationary power source, stationary control logic, a stationary receiver, a stationary antenna, and a stationary visual/audible indicator, and being configured to receive the signal having the predetermined minimum signal strength and the predetermined frequency, said at least one stationary vehicle pursuit receiving device being located in an external environment.

13: The vehicle pursuit caution light system according to claim 12, wherein said mapping display is configured to cause an indication of a location of the transmitting device in a blinking yellow color and to cause the mobile audible indicator to emit a designated sound at a rate dependent upon the strength of the signal received by the associated vehicle pursuit receiving device.

14: The vehicle pursuit caution light system according to claim 13, wherein said designated sound is a voice message.

15: The vehicle pursuit caution light system according to claim 14, wherein said voice message is ‘Pursuit in Progress’.

16: The vehicle pursuit caution light system according to claim 13, wherein said designated sound is a bell.

17: The vehicle pursuit caution light system according to claim 13, wherein said designated sound is a buzzer.

18: The vehicle pursuit caution light system according to claim 12, wherein said mapping display is further configured to provide constant illumination and the mobile audible indicator is further configured to provide constant sound emission when the strength of the signal received by the associated vehicle pursuit receiving device reaches a predetermined maximum level.

19: The vehicle pursuit caution light system according to claim 12, wherein said predetermined maximum signal power is effective for about one-half mile.
